(19) United States
(12) Patent Application Publication
(10) Pub. No.: US 2026/0361071 A1
(43) Pub. Date: Nov. 12, 2026

(54) EARTH GROUND VOLTAGE COMPARATOR SYSTEM AND METHOD

(71) Applicant: Cheng USA, Inc., San Francisco, CA (US)

(72) Inventor: Michael T. Miles, Niles, MI (US)

(21) Appl. No.: 19/204,007

(22) Filed: May 9, 2025

(51) Int. Cl. H02H 3/32; H02H 1/00; H02H 5/10

(52) U.S. Cl. CPC H02H 3/325; H02H 1/0007; H02H 5/105

(57) ABSTRACT

A circuit is provided for reducing a risk of electrical shock from a power connection between a power pedestal and a mobile apparatus power interface comprising: a plurality of voltage sensors for sensing a first voltage between a source ground conductor and a chassis ground of the mobile apparatus, a second voltage between a source neutral conductor and the chassis ground, and a third voltage between a source line conductor and the chassis ground; a plurality of switches; and a processor coupled to the sensors and switches and configured to indicate a faulty power connection in response to any of the voltages failing a threshold comparison, and to close the switches to connect the source ground conductor to the ground conductor, the source neutral conductor to the neutral conductor, and the source line conductor to the line conductor in respond each of the voltages passing the threshold comparison.

### TECHNICAL FIELD

The present disclosure relates to electrical power safety and more particularly to systems and method for assessing the safety of a shore power source and vehicle connections before connecting the shore power to a power interface of the vehicle.

### BACKGROUND

The AC power connections for a recreational vehicle (“RV”) require attaching a shore power plug including Line (“L”), Neutral (“N”), and Ground (“G”) conductors to the respective power source terminals of a power source. For 50 amp service, there are two line conductors (L1 and L2). Simply connecting the plug of the RV to the receptacle should provide a safe connection if everything is properly wired and in good condition. However, the power source may be faulty, with missing, disconnected, or mis-wired conductors, and that can create a very dangerous situation that is likely to cause electric shock and human injury.

### SUMMARY

In one embodiment, the present disclosure provides a method for reducing a risk of electrical shock from a power connection between a power pedestal and a power interface of a mobile apparatus, comprising: sensing a first voltage between a ground conductor of the power pedestal and a chassis ground of the mobile apparatus; sensing a second voltage between a neutral conductor of the power pedestal and the chassis ground; sensing a third voltage between a line conductor of the power pedestal and the chassis ground; indicating a faulty power connection in response to any of the first voltage being above or outside a first range of a first threshold, the second voltage being above or outside a second range of a second threshold, or the third voltage being below or outside a third range of a third threshold; and in response to the first voltage being below or within the first range of the first threshold, the second voltage being below or within the second range of the second threshold, and the third voltage being above or within the third range of the third threshold, closing a plurality of switches to connect the ground conductor to a ground conductor of the power interface, the neutral conductor to a neutral conductor of the power interface, and the line conductor to a line conductor of the power interface. In one aspect of this embodiment, the mobile apparatus is a recreational vehicle. In another aspect, sensing the first, second and third voltages, indicating a faulty power connection and closing a plurality of switches are performed by a processor and each of the first, second and third thresholds are values stored in a memory device. In another aspect, the first threshold is approximately 40 volts, the second threshold is approximately 40 volts and the third threshold is approximately 90 volts. In yet another aspect, the third threshold is the sensed first voltage and the sensed second voltage, the third voltage is below or outside the third range of the third threshold when the third voltage is below or outside the third range of the sensed first voltage and below or outside the third range of the sensed second voltage, and the third voltage is above or outside the third range of the third threshold when the third voltage is above or outside the third range of the sensed first voltage and above or outside the third range of the sensed second voltage. Another aspect of this embodiment further comprises: sensing a fourth voltage between a second line conductor of the power pedestal and the chassis ground; wherein indicating a faulty power connection is in response to any of the first voltage being above or outside a first range of a first threshold, the second voltage being above or outside a second range of a second threshold, the third voltage being below or outside a third range of a third threshold, or the fourth voltage being below or outside a fourth range of a fourth threshold; wherein closing a plurality of switches is in response to the first voltage being below or within the first range of the first threshold, the second voltage being below or within the second range of the second threshold, the third voltage being above or within the third range of the third threshold, and the fourth voltage being above or within the fourth range of the fourth threshold; and wherein closing a plurality of switches connects the ground conductor to the ground conductor of the power interface, the neutral conductor to the neutral conductor of the power interface, the line conductor to the line conductor of the power interface, and the second line conductor to a second line conductor of the power interface. In a variation of this aspect, the fourth threshold is approximately equal to the third threshold. In another variation, the method further comprises: comparing a phase of the third voltage to a phase of the fourth voltage; wherein indicating a faulty power connection is further in response to a phase difference between the third voltage and the fourth voltage being outside a predetermined range; and wherein closing a plurality of switches is further in response to the phase difference being within the predetermined range. In a further variation, the predetermined range is between approximately 110 degrees and 250 degrees. In another aspect of this embodiment, the method further comprises: determining whether the first voltage and the second voltage are substantially equal to one another and both elevated by an amount relative to an expected voltage; determining whether the third voltage is elevated by the amount; in response to the first voltage and the second voltage being substantially equal and elevated by the amount and the third voltage being elevated by the amount, shifting an original first threshold to the first threshold, shifting an original second threshold to the second threshold and shifting the original third threshold to the third threshold. In yet another aspect, closing a plurality of switches includes closing a first switch to connect the ground conductor to the ground conductor of the power interface, then closing a second switch to connect the neutral conductor to the neutral conductor of the power interface, then closing a third switch to connect the line conductor to the line conductor of the power interface. In another aspect, indicating a faulty power connection includes activating a visual indicator.

In another embodiment, the present disclosure provides an earth ground voltage comparator (“EGVC”) circuit for reducing a risk of electrical shock from a power connection between a power pedestal and a power interface of a mobile apparatus, comprising: a first voltage sensor configured to sense a first voltage between a ground conductor of the power pedestal and a chassis ground of the mobile apparatus; a second voltage sensor configured to sense a second voltage between a neutral conductor of the power pedestal and the chassis ground; a third voltage sensor configured to sense a third voltage between a line conductor of the power pedestal and the chassis ground; a plurality of switches connected between the power pedestal and the power interface; and a processor in communication with the first sensor, the second sensor and the third sensor, the processor being configured to indicate a faulty power connection in response to any of the first voltage being above or outside a first range of a first threshold, the second voltage being above or outside a second range of a second threshold, or the third voltage being below or outside a third range of a third threshold; wherein the processor is further configured to respond to the first voltage being below or within the first range of the first threshold, the second voltage being below or within the second range of the second threshold, and the third voltage being above or within the third range of the third threshold, by closing the plurality of switches to connect the ground conductor to a ground conductor of the power interface, the neutral conductor to a neutral conductor of the power interface, and the line conductor to a line conductor of the power interface. In one aspect of this embodiment, the mobile apparatus is a recreational vehicle. In another aspect, each of the first, second and third thresholds are values stored in a memory device coupled to the processor. In another aspect, the circuit further comprises: a fourth voltage sensor configured to sense a fourth voltage between a second line conductor of the power pedestal and the chassis ground; wherein the processor is configured to indicate a faulty power connection is in response to any of the first voltage being above or outside a first range of a first threshold, the second voltage being above or outside a second range of a second threshold, the third voltage being below or outside a third range of a third threshold, or the fourth voltage being below or outside a fourth range of a fourth threshold; wherein the processor is configured to close the plurality of switches in response to the first voltage being below or within the first range of the first threshold, the second voltage being below or within the second range of the second threshold, the third voltage being above or within the third range of the third threshold, and the fourth voltage being above or within the fourth range of the fourth threshold; and wherein the processor closing the plurality of switches includes connecting the ground conductor to the ground conductor of the power interface, the neutral conductor to the neutral conductor of the power interface, the line conductor to the line conductor of the power interface, and the second line conductor to a second line conductor of the power interface. In a variation of this aspect, the fourth threshold is approximately equal to the third threshold. In another aspect of this embodiment, the plurality of switches includes a first switch connected between the ground conductor and the ground conductor of the power interface, a second switch connected between the neutral conductor to the neutral conductor of the power interface, and a third switch connected between the line conductor to the line conductor of the power interface, wherein the processor is configured to close the first switch before the second switch and the second switch before the third switch. Another aspect further comprises a visual indicator coupled to the processor, wherein the processor is configured to indicate a faulty power connection by activating the visual indicator. In another aspect, the EGVC circuit is mounted to the mobile apparatus. In yet another aspect, the EGVC circuit is detachable from the mobile apparatus.

In yet another embodiment of the present disclosure, a circuit is provided for reducing a risk of electrical shock from a power connection between a power pedestal having a source ground conductor, a source neutral conductor and a source line conductor and a mobile apparatus power interface having a ground conductor, a neutral conductor and a line conductor, comprising: a plurality of voltage sensors including a first sensor configured to sense a first voltage between the source ground conductor and a chassis ground of the mobile apparatus, a second sensor configured to sense a second voltage between the source neutral conductor and the chassis ground, and a third sensor configured to sense a third voltage between the source line conductor and the chassis ground; a plurality of switches including a first switch connected between the source ground conductor and the ground conductor, a second switch connected between the source neutral conductor and the neutral conductor, and a third switch connected between the source line conductor and the line conductor; and a processor coupled to the plurality of voltage sensors and the plurality of switches, the processor being configured to indicate a faulty power connection in response to any of the first voltage exceeding a first threshold, the second voltage exceeding a second threshold, or the third voltage being less than a third threshold; wherein the processor is further configured to close the plurality of switches to connect the source ground conductor to the ground conductor, the source neutral conductor to the neutral conductor, and the source line conductor to the line conductor in response to the first voltage being less than the first threshold, the second voltage being less than the second threshold, and the third voltage exceeding the third threshold.

In yet another embodiment, the present disclosure provides a circuit for reducing a risk of electrical shock from a power connection between a power pedestal having a source ground conductor and a mobile apparatus power interface having a ground conductor, comprising: a voltage sensor configured to sense a first voltage between the source ground conductor and a chassis ground of the mobile apparatus; a switch connected between the source ground conductor and the ground conductor; and a processor coupled to the voltage sensor and the switch, the processor being configured to indicate a faulty power connection in response to the first voltage exceeding a first threshold; wherein the processor is further configured to close the switch to connect the source ground conductor to the ground conductor in response to the first voltage being less than the first threshold.

### BRIEF DESCRIPTION OF THE DRAWINGS

The above mentioned and other features of the present disclosure, and the manner of attaining them, will become more apparent and the invention itself will be better understood by reference to the following description of embodiments taken in conjunction with the accompanying drawings, wherein:

FIG. 1 is a conceptual diagram of a power source and a vehicle;

FIG. 2 is a schematic diagram of one embodiment of an earth ground voltage comparator (“EGVC”) circuit according to the present disclosure;

FIG. 3 is a schematic diagram of another embodiment of an EGVC circuit according to the present disclosure; and

FIG. 4 is a flow chart of a method of providing an electrical connection between a power source and a vehicle.

Corresponding reference characters indicate corresponding parts throughout the several views. Unless stated otherwise the drawings are proportional and drawn to scale.

### DETAILED DESCRIPTION

The embodiments disclosed below are not intended to be exhaustive or to limit the invention to the precise forms disclosed in the following detailed description. Rather, the embodiments are chosen and described so that others skilled in the art may utilize their teachings.

The system disclosed herein is configured to protect RV users from electric shock due to faulty or mis-wired connection(s) to a power source. In certain embodiments, the present disclosure provides an earth ground voltage comparator (“EGVC”) circuit mounted aboard a vehicle such as an RV, which uses the metallic chassis of the vehicle as an earth ground sensor to measure the voltages and electrical contact terminations at the nearby electrical power source and to assess the risk of an electrical safety hazard before connecting the power source to the other onboard connections of the vehicle. The EGVC circuit helps prevent a “hot skin” (i.e., a high voltage chassis) on the RV upon being connected to a mis-wired power source, for example, a power source with no actual earth ground connection or a mis-wiring that connects the ground terminal (which should be connected to the RV chassis) to the line voltage.

As is further described below, electronic circuits and relays or switches in the EGVC circuit keep the power electrically disconnected from the RV load until the shore power plug is attached and the power source is determined to be active and safely wired based on voltage measurements. Then, if the power source and connections are considered safe, the switches are activated to connect the shore power from the power source to the RV. In certain embodiments, the ground conductor is connected first and disconnected last relative to the neutral conductor and the line conductor(s). If the condition of the power is determined to be unsafe, the EGVC circuit does not connect the power source to the RV.

As is also further described below, the EGVC circuit checks a set of voltage measurements to determine whether the power connection is safe enough to connect to the RV. More specifically, the circuit measures voltage from each of the conductors of the power source (or power pedestal) to the RV chassis ground.

It should be understood that the principles of the present disclosure may be combined with the subject matter disclosed in co-pending patent application S/N 19/182,790, filed on April 18, 2025, titled “TRANSIENT GROUND FAULT INTERRUPTER SYSTEM AND METHOD” (“the TGFI application”), the entire contents of which being expressly incorporated herein by reference. The EGVC circuit of the present disclosure may be integrated into a product that also includes a circuit according to the TGFI application as another layer of safety.

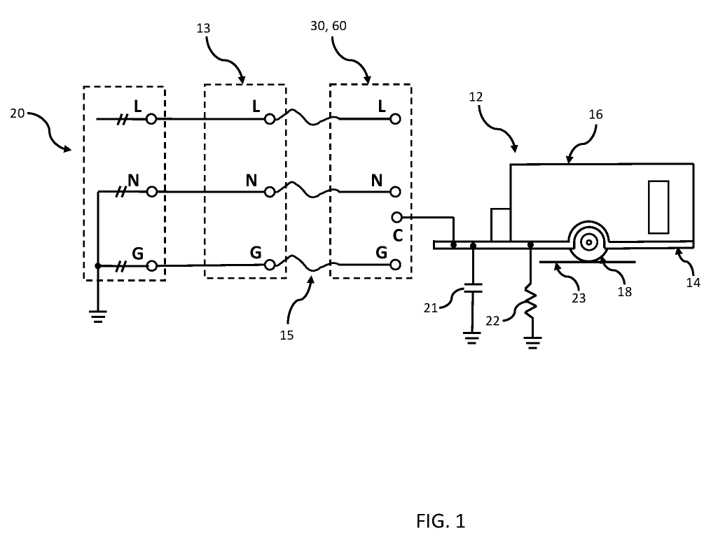

Referring now to FIG. 1, an example vehicle 12 is shown having a chassis 14 supporting an enclosure 16 and a plurality of tires 18 (one shown). In the description below, the vehicle 12 is referred to as “the trailer 12,” although the teachings of the present disclosure may be adapted for use with other vehicles or mobile apparatuses such as tractors, boats, aircraft, locomotives, power tools, appliances, power distribution devices, portable stages, enclosures, canopies, workbenches, tables or any other device that includes electrical equipment, wiring or receptacles that are configured to be connected to a power source. In this simplified diagram of FIG. 1, a terminal C is connected to the chassis 14 of the trailer 12. A shore power plug 13 at the end of a cord 15 includes conductors that mate with the conductors of the power pedestal 20 described below. The shore power plug 13 and cord 15 may include three or four contacts or conductors for connecting power to the trailer 12. These conductors include a ground conductor, a neutral conductor and one or two line conductors. The shore power plug 13 and cord 15 facilitate transfer of the power source power to a power interface of the vehicle 12 through an earth ground voltage comparator (“EGVC”) circuit 30, 60, which is described in detail below. In certain embodiments, the EGVC circuit 30, 60 is detachable from the trailer and part of the shore power plug 13 and/or cord 15. In other embodiments, the EGVC circuit 30, 60 is mounted to the trailer 12. Connecting the power source to the power interface of the vehicle 12 is safe only if the power source and the vehicle 12 are wired and connected correctly with properly functioning equipment.

In use, the shore power plug 13 is connected to a power source such as a power pedestal 20 provided at an RV park, which in the example depicted in FIG. 1 supports shore power conductors L, N, and G. As is further described below, the EGVC circuit 30, 60 of the present disclosure protects against coupling the power interface of the vehicle 12 to an incorrectly wired power pedestal 20, which may result in electrocution. In short, and as is further described below, the circuit measures the voltages between each of the shore power conductors L, N and G and the terminal C, which is connected to the chassis 14 of the vehicle 12.

Conventional circuits that measure the voltages between the shore power conductors L, N and G permit detection of several kinds of miswiring problems, but not all of the possible and potentially dangerous problems. For example, it is possible for both the ground conductor and the neutral conductor to be energized relative to the earth ground surrounding the terminal C, and this would create a severe safety hazard in and around the trailer 12 or device being connected to the shore power, even if the relative voltages are found to be acceptable.

Typically, the chassis 14 of a vehicle 12 is generally metallic, and needs to be safely grounded through the ground conductor G of the power pedestal 20 since people can touch metallic parts of the vehicle 12 connected to the chassis 14, such as door handles, siding, stairs, jacks, etc. As described below, the safe grounding of the chassis 14 is accomplished by determining that the ground conductor of the shore power plug is not open, mis-wired, or otherwise faulty before actually making the connection.

It should be understood that before being connected to the ground conductor of the power pedestal 20, the terminal C connected to the chassis 14 is floating and behaves in certain ways like an antenna, introducing noise into the measurements. The chassis 14 is coupled to the earth ground 23 below it by resistance through the tires 18, jacks, and any other devices touching the earth 23. In FIG. 1 the resistance is symbolized by the resistor 22. In addition, the chassis 14 is coupled to earth ground by capacitance, due to the proximity of all of its metal parts and the earth 23. The capacitance, symbolized by the capacitor 21, is often the primary coupling impedance, since the resistance 22 of the ground contact may be very high, especially if the ground 23 is dry sand, pavement, or other highly-resistive material. However, the amount of capacitive and resistive coupling that exists can allow meaningful measurements of the voltages relative to the terminal C. The impedance to ground 23 is normally less than one megohm, allowing voltage measurements with a high-impedance voltage sensor with an input impedance much higher than one megohm.

Generally, the EGVC circuit of the present disclosure measures, before making any electrical connections between the power pedestal 20 and the vehicle 12, the voltage from the chassis 14 to each of the conductors of the power pedestal 20 to be connected. Typically, with a safely functioning power pedestal 20 and a correctly-wired shore power plug 13, all in good condition, the voltages from the chassis 14 to the ground and neutral conductors will normally be very low, for example under one volt. The voltage from the chassis 14 to each line conductor of power pedestal 20 will normally be close to the line voltage that is present, for example within approximately five percent of the line voltage.

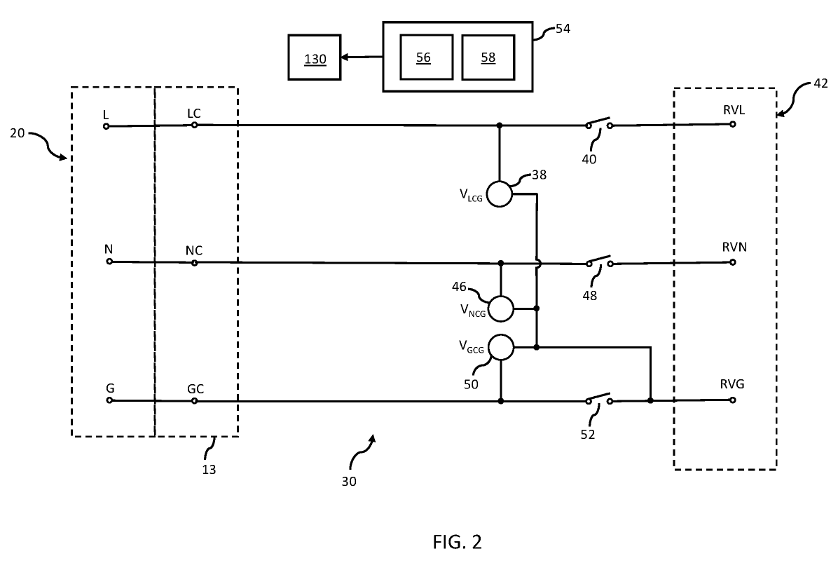

Referring now to FIG. 2, an EGVC circuit 30 according to one embodiment of the present disclosure is shown in a single-phase shore power application. As shown, the power pedestal 20 of the power source has a line conductor L, a neutral conductor N and a ground conductor G. The EGVC circuit 30 is connected to a shore power plug 13 which carries a line conductor LC, a neutral conductor NC and a ground conductor GC. When the plug 13 is coupled to the power pedestal 20, the line conductor L of the power pedestal 20 connects to the line conductor LC, the neutral conductor N of the power pedestal 20 connects to the neutral conductor NC and the ground conductor G of the power pedestal 20 connects to the ground conductor GC.

The line conductor LC is connected to a voltage sensor 38 which is connected between the line conductor LC and the ground conductor of the RV power interface 42 (i.e., RVG), which is electrically the same as terminal C. The line conductor LC is also connected to one side of a relay or switch 40, the other side of which is connected to the line conductor (i.e., RVL) of the RV power interface 42.

Another voltage sensor 46 is connected between the neutral conductor NC and the ground conductor RVG of the RV power interface 42. The neutral conductor NC is also connected to one side of a relay or switch 48, the other side of which is connected to the neutral conductor (i.e., RVN) of the RV power interface 42.

Another voltage sensor 50 is connected between the ground conductor GC and the ground conductor (i.e., RVG) of the RV power interface 42. A relay or switch 52 is also connected between the ground conductor GC and the ground conductor RVG of the RV power interface 42.

As is also shown in FIG. 2, the EGVC circuit 30 includes a controller 54 which includes at least one processor 56 and at least one memory device 58. As will be understood by those skilled in the art, the controller 54 may also include a plurality of other devices and components to accomplish the functions described herein. Although conductors connecting the controller 54 to components of the EGVC circuit 30 are not shown in FIG. 2, the controller 54 is in communication (via wires or wirelessly) with each of the switches 40, 48 and 52 and each of the voltage sensors 38, 46 and 50. The processor 56 is configured to obtain voltage measurements from the voltage sensors 38, 46 and 50, which are used, along with predetermined voltage thresholds stored in the memory device 48, to control the operation of the switches 40, 48 and 52 as is further described below. It should be understood that any reference to a “threshold” herein should be interpreted as meaning either a single value or a range of values.

In use, the switches 40, 48 and 52 are normally open. After the plug 13 is connected to the power pedestal 20, the processor 56 the processor 56 receives voltage measurements from the voltage sensor 38, which measures voltage between the line conductor LC and the vehicle chassis ground RVG (i.e., V_{LCG}), the voltage sensor 46, which measures voltage between the neutral conductor NC and the vehicle chassis ground RVG (i.e., V_{NCG}), and the voltage sensor 50, which measures voltage between the ground conductor GC and the vehicle chassis ground RVG (i.e., V_{GCG}). Each of the voltages V_{LCG}, V_{NCG} and V_{GCG} is compared by the processor 56 to a respective acceptable value stored in the memory device 58. It should be understood that while in this description the processor 56 is described as comparing voltages to predetermined threshold values, the function of comparing measured voltages to threshold values could be performed in a variety of different ways by a variety of different electronical components and/or combinations of components.

If the voltage V_{NCG} is below and/or within a specific range of a predetermined threshold value (e.g., approximately 40 volts), then the connection is considered safe. If the voltage V_{GCG} is below and/or within a specific range of a predetermined threshold value (e.g., approximately 40 volts), then the connection is considered safe. Finally, if the voltage V_{LCG} is above and/or within a specific range of a predetermined threshold value (e.g., approximately 90 volts), then the connection is considered safe.

In other embodiments, the voltage V_{LCG} is compared to the actual measured voltages V_{NCG} and V_{GCG}. In such an embodiment, if the voltage V_{LCG} is above and/or within a specific range of both the measured voltages V_{NCG} and V_{GCG}, then the connection is considered safe. The measurements of the voltages between the line conductor LC, the neutral conductor NC and the ground conductor GC and the vehicle chassis ground RVG are made with a high-input-impedance measurement system, typically having an input impedance of more than 5 megohms.

Thus, if the processor 56 determines that each of the measured voltages V_{LCG}, V_{NCG} and V_{GCG} indicates a safe connection, then the processor 56 causes the switches 40, 48 and 52 to close, thereby connecting the power from the power pedestal 20 to the power interface 42 of the vehicle 12.

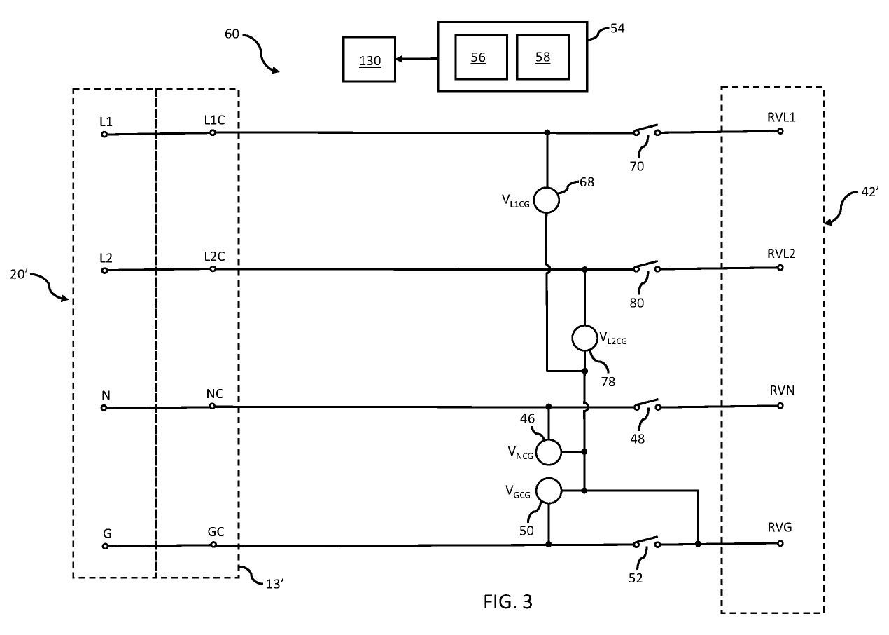

Referring now to FIG. 3, an EGVC circuit 60 according to another embodiment of the present disclosure is shown in a split-phase shore power application. In FIG. 3, components that are identical to those depicted in FIG. 2 and are connected in the same manner retain their reference numerals. As shown, the power pedestal 20’ in this application has a first line conductor L1, a second line conductor L2, a neutral conductor N and a ground conductor G. The first line conductor L1 is connected to a voltage sensor 68 which is connected between the first line conductor L1 and the ground conductor RVG of the RV power interface 42’. The first line conductor L1 is also connected to one side of a relay or switch 70, the other side of which is connected to the first line conductor (i.e., RVL1) of the RV power interface 42’.

The second line conductor L2 is similarly connected to a voltage sensor 78 which is connected between the second line conductor L2 and the ground conductor RVG of the RV power interface 42’. The second line conductor L2 is also connected to one side of a relay or switch 80, the other side of which is connected to the second line conductor (i.e., RVL2) of the RV power interface 42’.

As described above with reference to FIG. 2, the voltage sensor 46 is connected between the neutral conductor N of the power pedestal 20’ and the ground conductor RVG of the RV power interface 42’. The neutral conductor N of the power pedestal 20’ is also connected to the switch 48, the other side of which is connected to the neutral conductor RVN of the RV power interface 42’.

As is also described above with reference to FIG. 2, the voltage sensor 50 is connected between the ground conductor G of the power pedestal 20’ and the ground conductor RVG of the RV power interface 42’. The switch 52 is also connected between the ground conductor G of the power pedestal 20’ and the ground conductor RVG of the RV power interface 42’.

In this EGVC circuit 60, as with the EGVC circuit 30 of FIG. 2, the connecting conductors enabling communication between the controller 54 and each of the switches 70, 80, 48 and 52 and each of the voltage sensors 68, 78, 46 and 50 are not shown. The processor 56 is configured to obtain voltage measurements from the voltage sensors 68, 78, 44, 46 and 50, which are used, along with voltage thresholds stored in the memory device 48, to control the operation of the switches 70, 80, 48 and 52 as is further described below.

In use, the switches 70, 80, 48 and 52 are normally open. After the plug 13’ is connected to the power pedestal 20’, the processor 56 receives voltage measurements from the voltage sensor 68, which measures voltage between the line conductor L1C and the vehicle chassis ground RVG (i.e., V_{L1CG}), the voltage sensor 78, which measures voltage between the line conductor L2C and the vehicle chassis ground RVG (i.e., V_{L2CG}), the voltage sensor 46, which measures voltage between the neutral conductor NC and the vehicle chassis ground RVG (i.e., V_{NCG}), and the voltage sensor 50, which measures voltage between the ground conductor GC and the vehicle chassis ground RVG (i.e., V_{GCG}). Each of the voltages V_{L1CG}, V_{L2CG}, V_{NCG} and V_{GCG} is compared by the processor 56 to a respective predetermined threshold value stored in the memory device 58. If the voltage V_{NCG} is below and/or within a specified range of the predetermined threshold value (e.g., approximately 40 volts), then the connection is considered safe. If the voltage V_{GCG} is below and/or within a specified range of the predetermined threshold value (e.g., approximately 40 volts), then the connection is considered safe. If the voltage V_{L1CG} is above and/or within a specified range of the predetermined threshold value (e.g., approximately 90 volts), then the connection is considered safe. If the voltage V_{L2CG} is above and/or within a specified range of the predetermined threshold value (e.g., approximately 90 volts), then the connection is considered safe. In other embodiments, the voltage V_{L1CG} is compared to the actual measured voltages V_{NCG} and V_{GCG}. In such an embodiment, if the voltage V_{L1CG} is above and/or within a specified range of both the measured voltages V_{NCG} and V_{GCG}, then the connection is considered safe. In other embodiments, the voltage V_{L2CG} is compared to the actual measured voltages V_{NCG} and V_{GCG}. In such an embodiment, if the voltage V_{L2CG} is above and/or within a specified range of both the measured voltages V_{NCG} and V_{GCG}, then the connection is considered safe.

The measurements of the voltages between the line conductor L1C and the vehicle chassis ground RVG, the line conductor L2C and the vehicle chassis ground RVG, the neutral conductor NC and the vehicle chassis ground RVG and the ground conductor GC and the vehicle chassis ground RVG are made with a high-input-impedance measurement system, typically having an input impedance of more than 5 megohms.

Thus, if the processor 56 determines that each of the measured voltages V_{L1CG}, V_{L2CG}, V_{NCG} and V_{GCG} indicate safe connections, then the processor 56 causes the switches 70, 80, 48 and 52 to close, thereby connecting the power from the power pedestal 20’ to the power interface 42’ of the vehicle 12.

In an alternative embodiment of the EGVC circuit 60 (i.e., for dual-phase (50 amp) connections), the phase between the voltage on the line conductor L1C and the voltage on the line conductor L2C is checked. If the two line conductors L1C and L2C of the 50 amp split-phase power are mis-wired and actually in phase, the neutral conductor NC could carry up to 100 amps instead of the normal approximately zero amps when the conductors L1C and L2C are out-of-phase and canceled. This condition may present a fire hazard since the neutral wiring is only for 50 amps. The phase between these voltages should be in a speciﬁc range which is safe for the vehicle 12, for example, a predetermined range of between approximately 110 degrees to 250 degrees. If the phase is outside the predetermined range, the connection is considered unsafe, and the power from the power pedestal 42’ is not connected to the power interface 42’ of the vehicle 12. A neutral current sensor may be used to verify overcurrent conditions and induce an automatic shut-off.

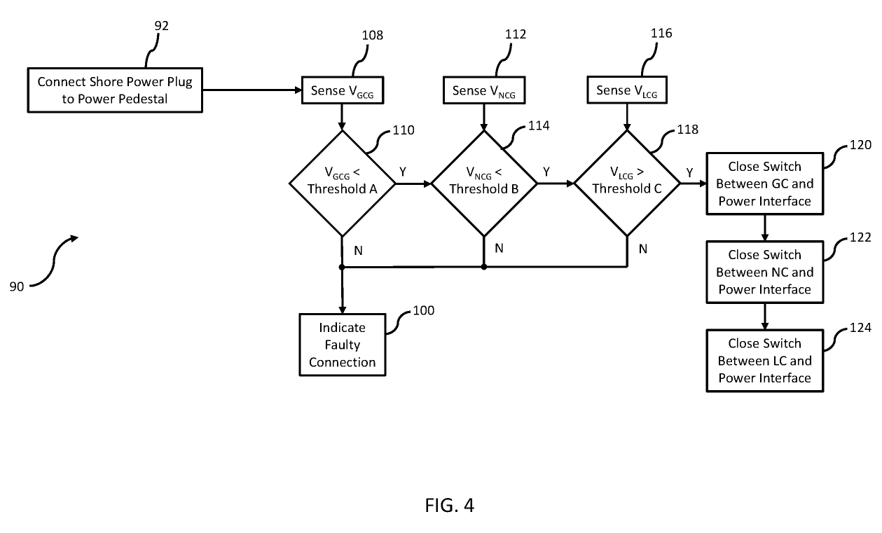

Referring now to FIG. 4, a method of providing an electrical connection between a power source and a vehicle is shown. The following description will make reference to the EGVC circuit 30 of FIG. 2. It should be understood, however, that a similar method may be carried out using the EGVC circuit 60 of FIG. 3 performing the additional steps described above. In certain embodiments, the method 90 begins at step 92 when a plug 13 of an EGVC circuit 30 is inserted into a power pedestal 20.

The processor 56 then proceeds to receive sensed voltages and compare those sensed voltages to predetermined threshold values to confirm the safety of the connections between the power pedestal 20 and the power interface 42 of the vehicle 12 in the manner described above with reference to FIG. 2. Specifically, the processor receives the sensed voltage V_{GCG} from the voltage meter 50 (step 108) and compares it to a threshold A (step 110) to determine that it is below and/or within a specified range of the threshold A (e.g., approximately 40 volts), receives the sensed voltage V_{NCG} from the voltage meter 46 (step 112) and compares it to a threshold B (step 114) to determine that it is below and/or within a specified range of the threshold B (e.g., approximately 40 volts), and receives the sensed voltage V_{LCG} from the voltage meter 38 (step 116) and compares it to a threshold C (step 118) to determine that it is above and/or within a specified range of the threshold C (e.g., approximately 90 volts).

If the voltage V_{GCG} is above and/or outside the specified range of the threshold A, if the voltage V_{NCG} is above and/or outside the specified range of the threshold B, or if the voltage V_{LCG} is below and/or outside the specified range of the threshold C, then the processor 56 initiates an action to indicate to a user the existence of a faulty connection at step 100. For example, the processor 56 may activate a visual indicator 130 such as an LED coupled to the EGVC circuit 30 (see FIG. 2) to indicate to the user that power will not be connected between the power pedestal 20 and the power interface 42 of the vehicle 12. The indicator 130 may provide this unsafe indication by glowing the color red.

If, however, all of the voltages pass the comparisons to the predetermined thresholds, then it is safe to electrically connect the power from the power pedestal 20 to the power interface 42 of the vehicle 12. In certain embodiments, the ground connection is made first as indicated by step 120 (i.e., the processor 56 closes the switch 52), followed by the neutral connection as indicated by step 122 (i.e., the processor 56 closes the switch 48) and the line connection as indicated by step 124 (i.e., the processor 56 closes the switch 40). In certain embodiments, when the processor 56 determines that it is safe to electrically connect the power as described above, the processor 56 may cause the indicator 130 (FIG. 2) to illuminate a different color such as green.

It should be understood that in certain embodiments the steps depicted in FIG. 4 may be performed in a different order than that described above. Additionally, it should be understood that in certain embodiments, the power connections between the power pedestal 20 and the power interface 42 of the vehicle 12 may be made if the processor 56 determines that the voltages satisfy relative thresholds. For example, if the voltages V_{GCG} and V_{NCG} are substantially equal to one another but at an elevated level, and if V_{LCG} is also above the expected value by the same amount, then processor 56 may shift the absolute thresholds (especially if all three voltages V_{GCG}, V_{NCG} and V_{LCG} are in phase) to relative thresholds. Based on these relative thresholds, the power connection may be determined by the processor 56 to be safe.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still cooperate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

This detailed description is to be construed as examples and does not describe every possible embodiment, as describing every possible embodiment would be impractical, if not impossible. One could implement numerous alternate embodiments, using either current technology or technology developed after the filing date of this application.

It should also be understood that, unless a term is expressly defined in this patent using the sentence "As used herein, the term ‘term’ is hereby defined to mean . . ." or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, the patent claims at the end of this patent application are not intended to be construed under 35 U.S.C. § 112(f) unless traditional means plus-function language is expressly recited, such as "means for" or "step for" language being explicitly recited in the claim(s).

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A method for reducing a risk of electrical shock from a power connection between a power pedestal and a power interface of a mobile apparatus, comprising:
sensing a first voltage between a ground conductor of the power pedestal and a chassis ground of the mobile apparatus;
sensing a second voltage between a neutral conductor of the power pedestal and the chassis ground;
sensing a third voltage between a line conductor of the power pedestal and the chassis ground;
indicating a faulty power connection in response to any of the first voltage being above or outside a first range of a first threshold, the second voltage being above or outside a second range of a second threshold, or the third voltage being below or outside a third range of a third threshold; and
in response to the first voltage being below or within the first range of the first threshold, the second voltage being below or within the second range of the second threshold, and the third voltage being above or within the third range of the third threshold, closing a plurality of switches to connect the ground conductor to a ground conductor of the power interface, the neutral conductor to a neutral conductor of the power interface, and the line conductor to a line conductor of the power interface.

2. The method of claim 1, wherein the mobile apparatus is a recreational vehicle.

3. The method of claim 1, wherein sensing the first, second and third voltages, indicating a faulty power connection and closing a plurality of switches are performed by a processor and each of the first, second and third thresholds are values stored in a memory device.

4. The method of claim 1, wherein the first threshold is approximately 40 volts, the second threshold is approximately 40 volts and the third threshold is approximately 90 volts.

5. The method of claim 1, wherein the third threshold is the sensed first voltage and the sensed second voltage, the third voltage is below or outside the third range of the third threshold when the third voltage is below or outside the third range of the sensed first voltage and below or outside the third range of the sensed second voltage, and the third voltage is above or outside the third range of the third threshold when the third voltage is above or outside the third range of the sensed first voltage and above or outside the third range of the sensed second voltage.

6. The method of claim 1, further comprising:
sensing a fourth voltage between a second line conductor of the power pedestal and the chassis ground;
wherein indicating a faulty power connection is in response to any of the first voltage being above or outside a first range of a first threshold, the second voltage being above or outside a second range of a second threshold, the third voltage being below or outside a third range of a third threshold, or the fourth voltage being below or outside a fourth range of a fourth threshold;
wherein closing a plurality of switches is in response to the first voltage being below or within the first range of the first threshold, the second voltage being below or within the second range of the second threshold, the third voltage being above or within the third range of the third threshold, and the fourth voltage being above or within the fourth range of the fourth threshold; and
wherein closing a plurality of switches connects the ground conductor to the ground conductor of the power interface, the neutral conductor to the neutral conductor of the power interface, the line conductor to the line conductor of the power interface, and the second line conductor to a second line conductor of the power interface.

7. The method of claim 6, wherein the fourth threshold is approximately equal to the third threshold.

8. The method of claim 6, further comprising:
comparing a phase of the third voltage to a phase of the fourth voltage;
wherein indicating a faulty power connection is further in response to a phase difference between the third voltage and the fourth voltage being outside a predetermined range; and
wherein closing a plurality of switches is further in response to the phase difference being within the predetermined range.

9. The method of claim 8, wherein the predetermined range is between approximately 110 degrees and 250 degrees.

10. The method of claim 1, further comprising:
determining whether the first voltage and the second voltage are substantially equal to one another and both elevated by an amount relative to an expected voltage;
determining whether the third voltage is elevated by the amount;
in response to the first voltage and the second voltage being substantially equal and elevated by the amount and the third voltage being elevated by the amount, shifting an original first threshold to the first threshold, shifting an original second threshold to the second threshold and shifting the original third threshold to the third threshold.

11. The method of claim 1, wherein closing a plurality of switches includes closing a first switch to connect the ground conductor to the ground conductor of the power interface, then closing a second switch to connect the neutral conductor to the neutral conductor of the power interface, then closing a third switch to connect the line conductor to the line conductor of the power interface.

12. The method of claim 1, wherein indicating a faulty power connection includes activating a visual indicator.

13. An earth ground voltage comparator (“EGVC”) circuit for reducing a risk of electrical shock from a power connection between a power pedestal and a power interface of a mobile apparatus, comprising:
a first voltage sensor configured to sense a first voltage between a ground conductor of the power pedestal and a chassis ground of the mobile apparatus;
a second voltage sensor configured to sense a second voltage between a neutral conductor of the power pedestal and the chassis ground;
a third voltage sensor configured to sense a third voltage between a line conductor of the power pedestal and the chassis ground;
a plurality of switches connected between the power pedestal and the power interface; and
a processor in communication with the first sensor, the second sensor and the third sensor, the processor being configured to indicate a faulty power connection in response to any of the first voltage being above or outside a first range of a first threshold, the second voltage being above or outside a second range of a second threshold, or the third voltage being below or outside a third range of a third threshold;
wherein the processor is further configured to respond to the first voltage being below or within the first range of the first threshold, the second voltage being below or within the second range of the second threshold, and the third voltage being above or within the third range of the third threshold, by closing the plurality of switches to connect the ground conductor to a ground conductor of the power interface, the neutral conductor to a neutral conductor of the power interface, and the line conductor to a line conductor of the power interface.

14. The EGVC circuit of claim 13, wherein the mobile apparatus is a recreational vehicle.

15. The EGVC circuit of claim 13, wherein each of the first, second and third thresholds are values stored in a memory device coupled to the processor.

16. The EGVC circuit of claim 13, further comprising:
a fourth voltage sensor configured to sense a fourth voltage between a second line conductor of the power pedestal and the chassis ground;
wherein the processor is configured to indicate a faulty power connection is in response to any of the first voltage being above or outside a first range of a first threshold, the second voltage being above or outside a second range of a second threshold, the third voltage being below or outside a third range of a third threshold, or the fourth voltage being below or outside a fourth range of a fourth threshold;
wherein the processor is configured to close the plurality of switches in response to the first voltage being below or within the first range of the first threshold, the second voltage being below or within the second range of the second threshold, the third voltage being above or within the third range of the third threshold, and the fourth voltage being above or within the fourth range of the fourth threshold; and
wherein the processor closing the plurality of switches includes connecting the ground conductor to the ground conductor of the power interface, the neutral conductor to the neutral conductor of the power interface, the line conductor to the line conductor of the power interface, and the second line conductor to a second line conductor of the power interface.

17. The EGVC circuit of claim 16, wherein the fourth threshold is approximately equal to the third threshold.

18. The EGVC circuit of claim 13, wherein the plurality of switches includes a first switch connected between the ground conductor and the ground conductor of the power interface, a second switch connected between the neutral conductor to the neutral conductor of the power interface, and a third switch connected between the line conductor to the line conductor of the power interface, wherein the processor is configured to close the first switch before the second switch and the second switch before the third switch.

19. The EGVC circuit of claim 13, further comprising a visual indicator coupled to the processor, wherein the processor is configured to indicate a faulty power connection by activating the visual indicator.

20. The EGVC circuit of claim 13, wherein the EGVC circuit is mounted to the mobile apparatus.

21. The EGVC circuit of claim 13, wherein the EGVC circuit is detachable from the mobile apparatus.

22. A circuit for reducing a risk of electrical shock from a power connection between a power pedestal having a source ground conductor, a source neutral conductor and a source line conductor and a mobile apparatus power interface having a ground conductor, a neutral conductor and a line conductor, comprising:
a plurality of voltage sensors including a first sensor configured to sense a first voltage between the source ground conductor and a chassis ground of the mobile apparatus, a second sensor configured to sense a second voltage between the source neutral conductor and the chassis ground, and a third sensor configured to sense a third voltage between the source line conductor and the chassis ground;
a plurality of switches including a first switch connected between the source ground conductor and the ground conductor, a second switch connected between the source neutral conductor and the neutral conductor, and a third switch connected between the source line conductor and the line conductor; and
a processor coupled to the plurality of voltage sensors and the plurality of switches, the processor being configured to indicate a faulty power connection in response to any of the first voltage exceeding a first threshold, the second voltage exceeding a second threshold, or the third voltage being less than a third threshold;
wherein the processor is further configured to close the plurality of switches to connect the source ground conductor to the ground conductor, the source neutral conductor to the neutral conductor, and the source line conductor to the line conductor in response to the first voltage being less than the first threshold, the second voltage being less than the second threshold, and the third voltage exceeding the third threshold.

23. A circuit for reducing a risk of electrical shock from a power connection between a power pedestal having a source ground conductor and a mobile apparatus power interface having a ground conductor, comprising:
a voltage sensor configured to sense a first voltage between the source ground conductor and a chassis ground of the mobile apparatus;
a switch connected between the source ground conductor and the ground conductor; and
a processor coupled to the voltage sensor and the switch, the processor being configured to indicate a faulty power connection in response to the first voltage exceeding a first threshold;
wherein the processor is further configured to close the switch to connect the source ground conductor to the ground conductor in response to the first voltage being less than the first threshold.
